(19) United States
(12) Patent Application Publication
(10) Pub. No.: US 2001/0034609 A1
(43) Pub. Date: Oct. 25, 2001

(54) System and method for managing personal and business assets

(76) Inventor: Gregg J. Dovolis, Edina, MN (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 09/795,569

(22) Filed: Feb. 28, 2001

Related U.S. Application Data
(60) Provisional application No. 60/185,949, filed on Feb. 29, 2000.

(51) Int. Cl. G06F 17/60

(52) U.S. Cl. 705/1

(57) ABSTRACT

A system and method for managing asset information includes a web server and a database in network communication with the Internet. The system captures and stores asset information, and permits consumers to access the asset information remotely over a secure Internet connection. The system permits users to customize the web site interface such that each user can view a customized web page. The system captures and stores transactional information from the point of sale, and permits users to manage their own asset information. The system can generate electronic product registrations, organize assets for insurance purposes, maintain and display user manuals and product information specific to the asset information, and permit the transfer of asset information to other users. Finally, the system provides a gift-registry system for users to create and provide limited access to a “wish list.”

### CROSS-REFERENCE TO RELATED APPLICATION(S)

This application claims priority from Provisional Application No. 60/185,949 filed on Feb. 29, 2000, entitled “System and Method for Managing Personal and Business Assets.”

### BACKGROUND OF THE INVENTION

The present invention relates to a system and method for managing personal and/or business assets. More specifically, the present invention relates to managing personal and business assets over the Iternet, including automatic entry of asset information from the point-of-sale and automatic warranty registration over the Internet.

With the growth of the Internet, the gathering of information has become easier, and the maintenance and accuracy of the information has become increasingly important. For consumers and businesses alike, accumulation of information is easier than retrieving the right information when it is needed. Typically, credit card companies record transaction information related to a particular customer; however, that customer may have multiple credit cards, so that the information is accumulated in different places by different credit card companies. In addition, though the transaction may be viewed over the Internet, the credit card company may provide no capacity to modify the transaction information or even to view information relative to the individual items purchased.

Warranty registrations, for instance, are typically included inside the shrink wrap packaging for products purchased in retail stores. Whether the product is purchased as a gift or purchased for personal use or even purchased for use in an office, the completion of the registration card often determines the expiration of a warranty.

In the case of electronic equipment, user manuals and various instruction manuals typically accompany the product in the box. However, retaining the information, the instruction manuals, the assembly instructions, warranty information, etc. requires storage space and organization, which many people do not have. More importantly, the information must be stored so that it can be found when needed.

Many people do not pay attention to warranty registration and other cards and inserts contained in the packaging. In the case of small electronics, generally people are interested in removing the product from the box, plugging it in, and turning it on. It is, therefore, no surprise that the phrase “plug and play” has become ubiquitous in the computer and electronics industry.

Nevertheless, people lose their registration cards, fail to fill them out, or simply throw them away before completing them. Whether the failure to complete the registration card is due to lack of time, inattention to detail, absence of registration cards inside the box, or any other number of reasons, ultimately the manufacturer loses out on crucial sales information. Though the manufacturer knows ultimately that the product was sold from the retail shelf, the manufacturer may not be able to determine anything about the purchaser. Most importantly, the demographic information associated with the purchaser is lost to the manufacturer for future sales reference.

Similarly with respect to a retail store, unless the consumer uses an in-store credit card, the retailer loses out on valuable information as well. Even if the consumer uses an in-store credit card, the demographic information associated with that card may be out of date or limited.

For the consumer, failure to fill out the registration card may ultimately prevent the user from exercising the warranty. Furthermore, lost instruction manuals and assembly instructions can cause users to waste valuable time looking for these documents. Finally, many consumers do not remember the exact date or amount of the purchase, and cannot find the receipt after time has passed.

In the case of wireless communication devices such as cellular telephones, manufacturers typically provide a time-limited warranty with their product packaging. Typically, the warranty guarantees that the manufacturer will repair or replace a defective device for free during some warranty period. Though most periods for wireless communication devices begin to run at the time of purchase, many consumers fail to fill out their registration. As taught by U.S. Pat. No. 6,163,693, it is possible to automatically register a device for purposes of determining the warranty date when the device connects with the system for the first time. Though the turn on date of the device may be close in time to the purchase date, typically there is a battery charging period and there may be some additional delay before the user charges the device prior to the initial connection. Thus, even for cellular telephone devices, the registration of the warranty information experiences a delay between the sale of the item and the initial registration.

Furthermore, with stereos and other devices, the first initial connection of the device cannot be easily monitored by the manufacturer. Consumers may purchase the product and never fill out the warranty registration form. Alternatively, consumers may provide inaccurate purchase date information because devices may be purchased and stored for an extended period before first use. In such a case, any damage done between purchase and initial turn on, might not be covered by warranty; however, the purchase date may be unavailable.

There is a need within the industry to provide warranty registration at the time of purchase. Furthermore, there is a need for a system for consumers to track and manage their own assets so that the majority of information is entered automatically at the time of purchase. Finally, there is a need for consumers to be able to easily retrieve and/or transfer warranty information.

### BRIEF SUMMARY OF THE INVENTION

The present system provides a simple and effective method for registering warranty information at the point of purchase. By registering with the system, the system provides a unique identifier and a password to the consumer. For all future purchases after registration with the system, simply swiping an identifier card transmits the purchase information to the system. The system permits the consumer to access, modify and append the purchase information. In addition, the system automatically completes any warranty registration associated with the product on behalf of the consumer. Furthermore, the system monitors the duration of the warranty period for each product so that a consumer may later visit the site to see when their warranty expires, to transfer warranties from one person to another if the product is given as a gift, and to view product instructions and other information available online for that particular product. Thus this system manages the information of the sale as well as the product information for the consumer via a secure Internet network. Finally, the system provides a means for consumers to view their purchases on a consumer web page and to personalize their consumer page so as to categorize their products in any way that makes sense to them.

### BRIEF DESCRIPTION OF THE DRAWINGS

FIG. 1 is a block diagram of the system of the present invention.

FIG. 2 is a schematic flow diagram of the registration process of the present invention.

FIG. 3 is a schematic flow diagram of the automated transaction entry process of the present invention.

FIG. 4 is a schematic flow diagram of the automated warranty registration process of the present invention.

FIG. 5 is a schematic flow diagram of the consumer interacting over the Internet with the system of the present invention.

FIG. 6 is a flow diagram of a consumer creating new subdirectories in the present invention.

FIG. 7 is a flow diagram of a consumer moving a product from one subdirectory to another in the present invention.

FIG. 8 is a flow diagram of the product information component of the present invention.

FIG. 9 is a flow diagram of the “add new product” process of the asset management system.

FIG. 10 is a flow diagram of the transfer process of the asset management system.

FIG. 11 is a flow diagram of the “do-it-yourself” component of the present invention.

FIG. 12 is a flow diagram of the “wish list” or “gift registry” component of the present invention.

### DETAILED DESCRIPTION

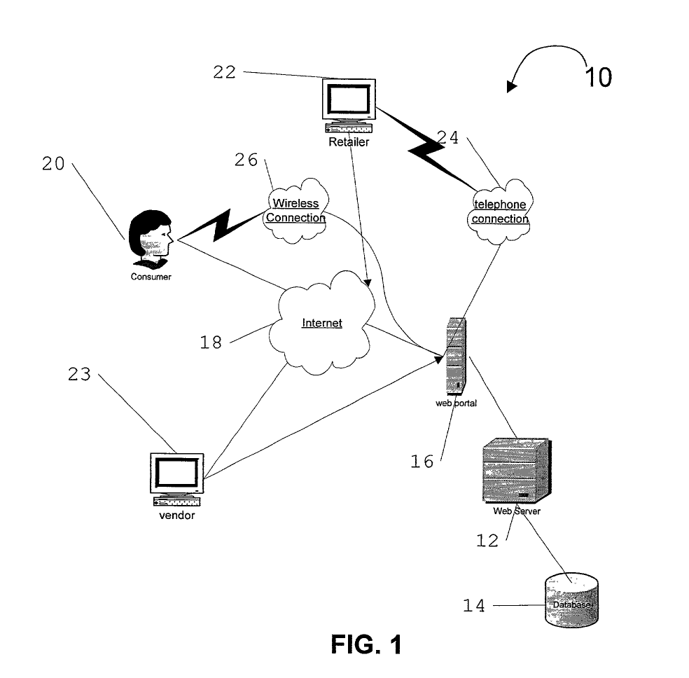

FIG. 1 represents a block diagram of the system 10 of the present invention. The automated asset management system 10 of the present invention includes a web server 12 having a database 14 connected via a network to a web portal 16. The web portal 16 is in turn connected to the Internet 18. Consumers 20, retailers 22, and manufacturers or vendors 23 interact with the web server 12 through the web portal 16 over the Internet 18. In addition to the Internet 18, retailers 22 may also access the web server 12 via a telephone connection 24.

Consumer 20 and retailers 22 interact with the web server 12 over the Internet 18 using any number of known protocols, including web browsers, etc. Additionally, consumer 20 may interact using cellular telephones or digital telephones via a wireless application protocol (WAP) connection 26.

The retailer 22 may contact or interact with a web server 12 via telephone connection (wireless or land-line) 26 as well, to provide an alternative means for transferring the information. Telephone postings may be performed automatically by the retailer 22 immediately upon purchase of the product, or at a later time so designated by the retailer 22.

Generally, the system 10 captures product information at the point of purchase, and permits consumers 20 to view the product purchase information by visiting a web site and entering a unique identifier and password at a later time. Thus, each consumer 20 has his or her own private data file of purchases, which can be customized. The system 10 provides a clearinghouse for purchase information of the consumer 20, allowing the consumer 20 to track his or her own purchases, to manage asset information by adding other items and deleting items over time, to view product manuals and repair information, to view warranty information and even to research other subjects in the database. As new items are purchased by consumers 20, the database 14 grows to include information about new products.

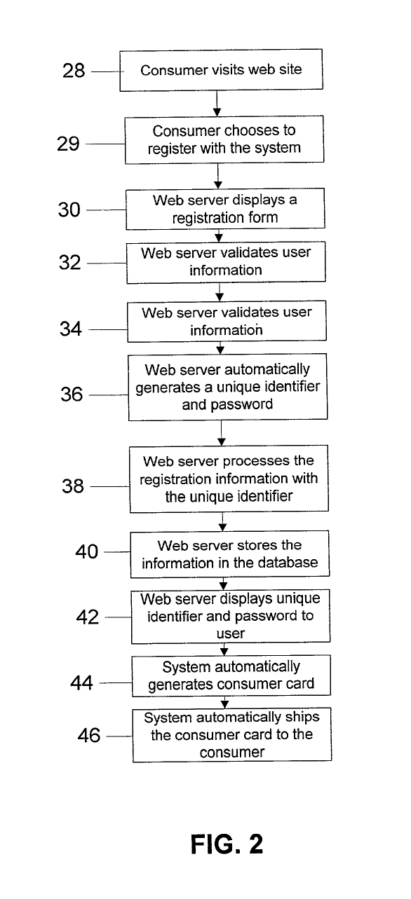

Registration with the asset management system 10 is a prerequisite to using the system 10. As shown in FIG. 2, first the consumer 20 visits the web site interface (step 28) of the system 10. If the consumer 20 chooses to register with the system 10, the web server 12 displays a registration form (step 30) to the consumer 20. The registration form requests such information as a first name, a last name, a mailing address, a phone number, and various other demographic information such as annual salary range, occupation, as well as information about the family ofthe consumer 20, etc. Generally, the registration form requests at least as much information as required on a standard product registration form or warranty card.

Once the consumer 20 completes the registration form, the consumer 20 submits the registration form (step 32). The web server 12 automatically validates the user information (step 34), and generates a unique identifier and a password (step 36) for the consumer 20. The web server 12 processes the registration information (step 38) and stores the registration information, unique identifier and password (step 40) in database 14. Then, the system 10 displays the unique identifier and password (step 42) for the consumer 20. Finally, the system 10 automatically generates a consumer card (step 44) for the consumer 20, and ships the consumer card via the mail (step 46) to the consumer 20 for future use.

In an alternative embodiment, the registration process could be effected at the point of sale. As with prepaid phone cards, the bar coded cards could be available for purchase or simple distribution at the retail point of sale. For instance, if a retailer 22 were interested in partnering with the asset management system 10, the retailer 22 could invite consumer 20 to register with the system.

The unique identifier can be captured from a consumer card, a magnetic stripe on a card, or any other media for transferring information to the cash register at the retailer or service desk. Generally, the purpose of the consumer card is to transfer the unique identifier to the processor of the cash register for transmittal with the product information, independent of the method of payment. Thus, if the consumer 20 purchases a product with cash, the system 10 still captures the product information. No matter how the product is purchased, the system 10 can serve as a central storage for all consumer transactions.

For corporations that offer in-store credit cards, the asset management system 10 provides the advantage of gathering demographic information about consumers who buy equipment and goods from other companies. The consumer card allows the system 10 to gather and store such purchases in its database, so that valuable retail information is not lost.

Customer service at the retailer 22 may perform the data entry over the Internet 18 directly for the consumer 20 in conjunction with scanning the card so as to register the consumer 20 for the existing account. In such a situation, in one embodiment, the number printed on the card below the bar code is the unique identifier and the initial login password is provided on the card and covered by a peelable sticker. The initial user login then requires an additional step of creating a new password for the account. Alternatively, the retail store may have a form similar to a warranty registration form for the consumer 20 to fill out prior to checkout at the cash register. In another embodiment, the card may contain a magnetic strip containing the unique identifier information.

If the cash registers have a connection to the Internet 18, registration can be performed over the Internet 18 on behalf of the consumer 20 at checkout. If not, the registration form can be mailed in and the data can be entered into database 14. Numerous other embodiments or possibilities could be effected for distributing the card to the consumer 20.

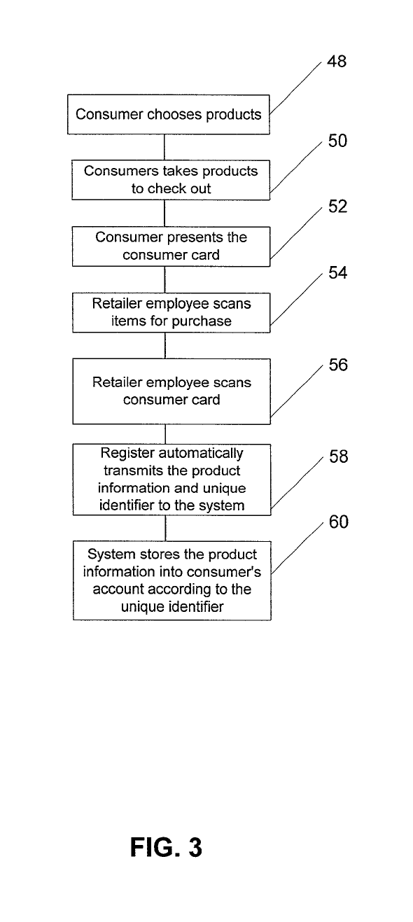

As shown in FIG. 3, once the consumer 20 is registered and has been issued a consumer card, the consumer 20 may use the consumer card at any participating retail store. First, the consumer 20 chooses items from the store (step 48) which the consumer 20 wishes to purchase. Then, the consumer 20 takes those items to the check out register (step 50) and presents his or her assets management card or consumer card (step 52) together with credit card, cash, check or whatever other means of payment. The retail employee then scans the items for purchase (step 54) and scans the asset management card (step 56) with the bar code reader. When the retail employee sweeps the credit card through the credit card machine or otherwise completes the commercial transaction, the retail cash register system then automatically transmits the product information and the unique identifier (step 58) of the consumer 20 over the Internet 18 or via telephone connection directly to the database 14 of the web server 12. The database 14 does not require a password from the retailer 22 because communication between the retailer 22 and the database 14 is one-way. Information is posted to the database 14 by the retailer 22, but retailer 22 does not gain access to purchase information about the consumer 20. Thus, the system 10 captures the purchase information at the point of sale, irrespective of the method of payment. Even if the customer pays cash or exchanges an item, the transaction can be captured by the system 10.

Finally, the system 10 stores the product information in a database record (step 60) related to the account identified by the unique identifier in the database 14. Thus, new purchases after the registration has been completed are automatically added to the asset management account of the consumer 20.

The unique identifier can be retrieved via many different means. The unique identifier may be contained on a bar code card or on a magnetic strip. The unique identifier could be biometric, voice activated, etc. Though the description of the present invention largely uses the phrase “unique identifier” to identify a consumer, the unique identifier may be comprised of letters, numbers, images, or a combination thereof. The unique identifier can be a user name, e-mail address, randomly generated number, a code, retinal scan, finger print, or any other known identifier.

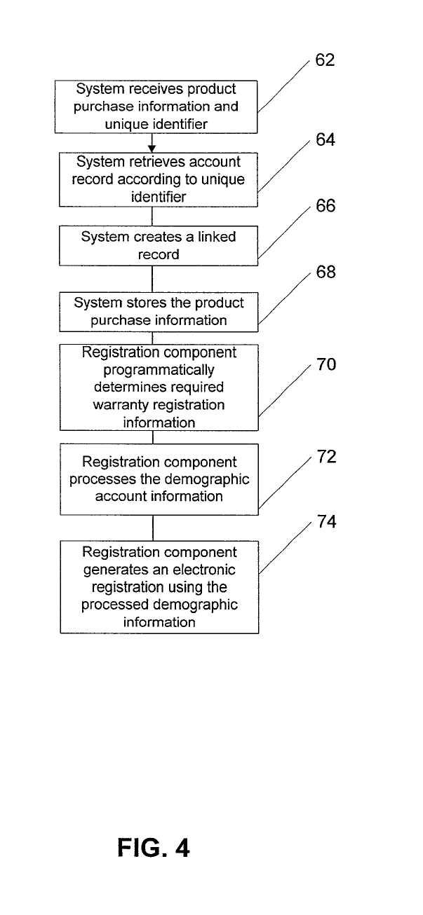

As shown in FIG. 4, the asset management system 10 receives product purchase information and a unique identifier (step 62) from the retailer 22. The system 10 retrieves the account record based on the unique identifier (step 64), and creates a linked record for storing the product purchase information (step 66). Then, the system 10 stores the product purchase information (step 68) in the database 14. Next, the system 10 programmatically determines the warranty registration information required (step 70) by the manufacturer 23 associated with the product purchased. The warranty registration information can be determined in a number of ways. First, the information can be obtained from the manufacturer 23 and manually entered into the database 14. Alternatively, using a custom search engine and a database of manufacturer web site addresses, the warranty information can be acquired dynamically via the Internet. In the preferred embodiment, warranty information is bundled with the purchase information by the cash register of the retailer. Thus, even extended warranty purchase information would be captured by the system 10.

Then, the system 10 processes the demographic information contained in the account registration (step 72), and generates an electronic registration using the processed demographic information (step 74). The electronic registration generally contains the demographic information of consumer 20 required by the warranty registration form, including the product purchase date, the product code, and product specific information.

In some instances, the manufacturer 23 requires the product serial number to complete the registration process. If the product serial number is not contained in the bar code information and/or cannot be determined from the exterior of the box, consumer 20 may have to visit the system 10 and manually enter the required serial number to complete the product registration.

Generally, the asset management system 10 interacts with the existing system of the vendor 23 in order to electronically complete the registration form automatically. The advantage of the automated registration system 10 is that the consumer 20 no longer has to fill out the little registration cards. The cards contained in the packaging of the product purchased at the store can be discarded as they may have been anyway. Nevertheless, the registration is completed automatically (step 72) by the system 10 on behalf of the consumer 20. Furthermore, for those products for which registration is dependent on the point-of-purchase date, the registration is automatically effected at purchase time.

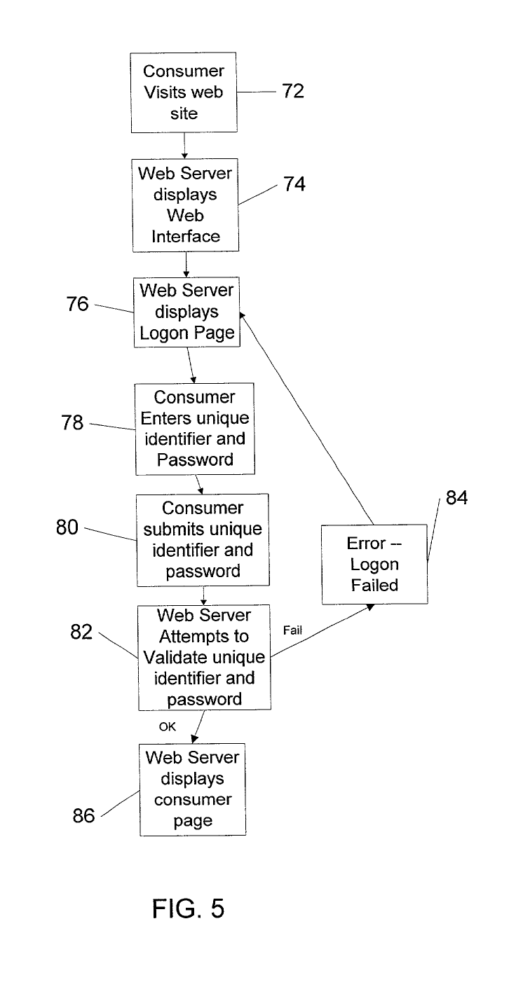

As shown in FIG. 5, a consumer 20, who has already registered with the asset management system 10, visits the website (step 72) by typing in an Internet 18 address or URL. The web server 12 displays an web site interface (step 74) where the consumer 20 may read various pieces of information, or sign on to the system 10 using their unique identifier and password. If the consumer 20 chooses to log onto the web server 12, the consumer 20 clicks on a link on the home page of the site and the web server 12 displays a secure login page (step 76). The consumer 20 enters his or her unique identifier and password (step 78) and submits the unique identifier and password (step 80) to the web server 12. The web server 12 validates the information (step 82) against its data store, and displays a new web page depending upon the result. If the unique identifier and password do not exist in the system 10 or if the unique identifier or password are entered incorrectly by the consumer 20, the system 10 is unable to validate the consumer 20 and displays an error page (step 84) before the system 10 displays the secure login page (step 76).

If the consumer 20 enters his or her unique identifier and password correctly, and the system 10 is able to validate the consumer 20 in the web server 12, the web server 12 displays a consumer web page (step 86). The consumer web page is specific to the consumer 20, meaning that each consumer 20 will see a unique web page containing product purchase information specific to that consumer 20. The consumer 20 can customize the web page according to his or her needs and organizational style.

The consumer page may be arranged in any format. In the preferred embodiment, the consumer page is divided into two areas: a list area and a display area. The list area of the consumer page appears on the left half of the screen and contains a hierarchical list of subdirectories. The display area appears on the right half of the screen and contains a list of the purchase contained within the selected subdirectory. Initially, when a new consumer account is created, the only directory listed in the list area is the root directory, which identifies the user by unique identifier or name.

The consumer 20 may customize the list area by adding subdirectories and moving purchases from one subdirectory to another to organize his or her own consumer page on the web server 12. When a new purchase is registered on the website, the new purchase automatically appears in the root directory. When the consumer 20 logs on to the website, and views the consumer page, the consumer 20 can then move new purchases into various subdirectories.

In the preferred embodiment, the consumer page presents a visual interface which maybe customized by the consumer 20. Specifically, the consumer page allows consumers 20 to choose icons to associate with specific subdirectories and purchases. Consumers 20 can import icons in any web-based graphical format (such as GIF, JPEG, TIFF, etc.), or consumers 20 can select from a list of icons including folder images, document images, etc. In the preferred embodiment, each purchase and each folder can be associated with a different icon.

Furthermore, purchased items contain product purchase and pricing information, which may be useful for insurance purposes. To supplement the existing information, the consumer 20 can import a picture of the purchased item or asset and associate the picture with the asset information. For instance, if a consumer purchases a new armoire for the living room, the consumer visits the web site interface of the system 10 and uploads a digital picture of the armoire to store in the database 14. In the event of damage to the product, in addition to price and purchase information about the item, the system 10 can provide a digital picture of the item for the insurance claim.

As previously described, the consumer page presents multiple options to the consumer 20. From the consumer page, the consumer 20 can search for technical information, review warranty information, search for do-it-yourself information, add/delete/rename subdirectories, move product information, customize the display, add/move/transfer/delete product information, etc.

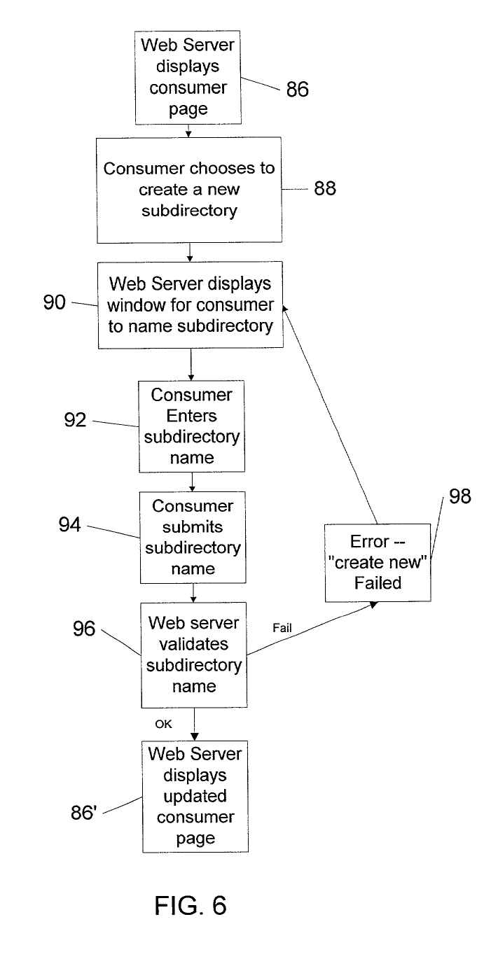

FIG. 6 illustrates a consumer 20 creating a new subdirectory on the web server 12. After logging in, the web server displays a consumer page (step 86). The consumer page presents a number of options. Assuming the consumer 20 chooses to create a new subdirectory (step 88), the web server displays a window (step 90), allowing the consumer 20 to name the new subdirectory. The consumer 20 enters a subdirectory name (step 92) and submits the subdirectory name (step 94) to the web server 12. The web server 12 validates the subdirectory name (step 96), by comparing the name against the subdirectories and file names already stored in the root directory of the consumer 20. If subdirectory or file having the identical name already exists, the web server 12 displays an error message (step 98), and displays a window for the consumer to enter a subdirectory name (step 90).

If the subdirectory name submitted in step 94 contains an error or cannot be used as a subdirectory name for some reason, the web server 12 displays an error message (step 98), and then displays a window for the consumer to enter a subdirectory name (step 90).

If the subdirectory name is valid, the web server creates the subdirectory, stores it in the database and displays an updated consumer page (step 86′). The updated consumer page contains the list of subdirectories, including the newly created subdirectory.

Consumers 20 may perform other operations on the subdirectories on the consumer page. For example, a consumer 20 can rename an existing subdirectory, delete a subdirectory, or change the visual appearance of the subdirectory. The steps associated with each of these other operations will be apparent to a worker skilled in the art. Furthermore, the deletion or renaming of a subdirectory should elicit a test by the web server 12 to determine whether the subdirectory contains products or the renamed subdirectory shares the same name as another subdirectory, respectively. With respect to customization of a subdirectory's appearance, various icons may be made available through a pull down menu or separate screen to select icons for each subdirectory. In addition, the web server 12 can permit the consumer 20 to upload images in known formats (such as GIF, TIFF, JPEG, etc.) to personalize or customize the consumer page.

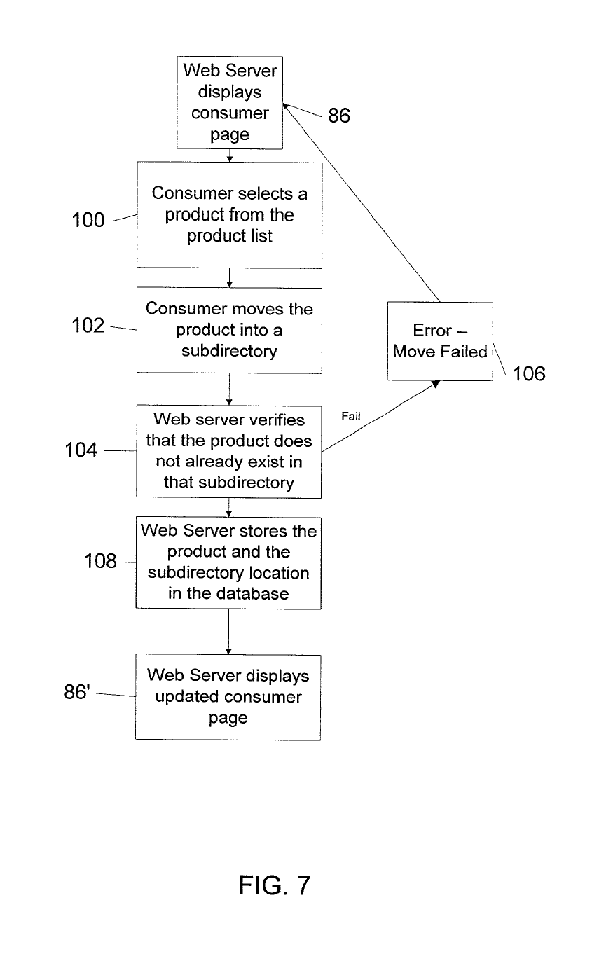

As shown in FIG. 7, after the consumer 20 logs into the system 10, the web server 12 displays the consumer page associated with that consumer 20. Product purchase information by default is arranged in the order of date of purchase; however, the consumer 20 can change the sort order. Generally, the product information is identified by a brief product identifier, but the consumer 20 can customize the identifier to be more recognizable to the consumer 20. Each product purchase listing is a separate record or file, linked to the account of the consumer 20.

If the consumer 20 chooses to move a product file into a subdirectory, the consumer 20 selects a product file from the list (step 100) and moves the product file into a subdirectory (step 102). Over the Internet, selecting and moving the product file may be effected by using a mouse to click on an item and, while holding the mouse button down, dragging the item into the appropriate subdirectory. If the computer is not mouse-driven or if the consumer 20 connects via wireless telephone, selecting and moving the product file may be effected by selecting options from a numbered list.

Once the consumer 20 moves the product file, the web server 12 verifies that the product file does not already exist in the subdirectory (step 104). Generally, two items having identical names cannot exist in the same subdirectory, so the web server 12 tests to make sure that moving a product file does not overwrite an existing product file in the subdirectory. If the product file already exists in the subdirectory, the web server 12 displays an error message (step 106) and then displays the consumer page (step 86). If the product file does not already exist in the subdirectory, the web server 12 stores the product file in the new subdirectory (step 108) and updates the database 14. Then, the web server 12 displays the updated consumer page (step 86′).

The capacity to move and organize information may be particularly useful for the consumer 20 who owns a small business or who maintains insurance of various items. For example, the consumer 20 might create a kitchen subdirectory, a dining room sudirectory, a living room subdirectory, a bathroom subdirectory, and a bedroom subdirectory. Items purchased for each of the rooms could be moved into the subdirectory created for the room where it resides. Thus, when the consumer 20 purchases a new television for the living room, the television purchase will initially appear under the root directory identified by the unique identifier. However, the consumer 20 may then drag and drop the purchased item into a living room subdirectory so as to show that the item purchased now appears in the living room. In the event of a fire or other catastrophe, the organization of the consumer 20 web page may provide a means for identifying the specific items in each room for insurance purposes. In addition, as the purchase information is included with the product information, the value paid for the item will be included as well. Thus, the asset management system 10 provides a central location to manage assets.

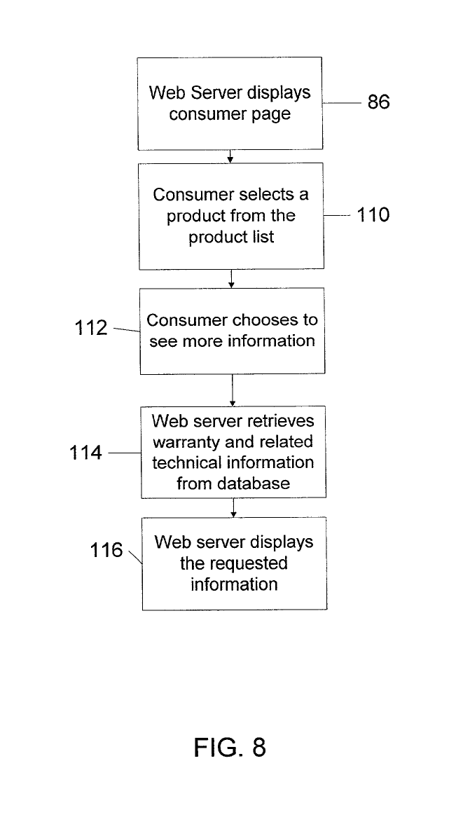

Referring now to FIG. 8, from the consumer page, the consumer 20 can view additional product information. First, the consumer logs onto the system, and the web server 12 displays the consumer page (step 86). Then, the consumer 20 selects a product file from the list (step 110). The product file selection process generally involves highlighting the product file in the list (using a mouse, arrow keys, or any other standard HTML method).

The consumer 20 chooses to see more information (step 112) by “double-clicking” on a product file, by highlighting the product file and selecting the choice from a menu button, or by any other known HTML method. The web server 12 retrieves warranty and related technical information from its database (step 114) and displays the requested information (step 116).

It is anticipated that consumer 20 may so wish to add items to the asset management site. For instance, prior to registration a consumer 20 may have purchased an item from a store and now the consumer 20 wishes to add the item to the consumer page.

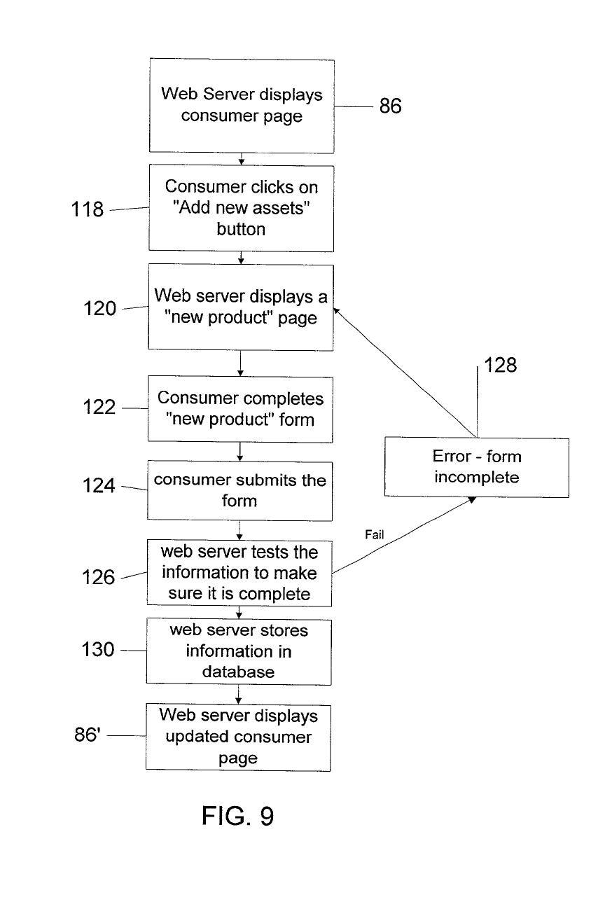

As shown in FIG. 9, if the consumer 20 chooses to add new items, the consumer 20 clicks on the add new assets button (step 118) and the web server 12 displays a “new product file” page (step 120). Typically, the new product file page requires purchase information regarding the particular product. The purchase information includes such information as the store name, the store location, the date of purchase, the item's UPC (Universal Product Code) number, price, etc. In addition, the new product file page requests warranty information (such as extended warranties, etc.). The new product file page provides space for other information, so the consumer 20 can customize the information to be stored. The consumer can also define custom data fields to store any other information of interest to the consumer. The consumer 20 can even upload digital images to the new product file page to provide a digital picture of the product for insurance or other purposes. Finally, new product file page permits the consumer 20 to name the product information file, so that the product file can be readily identified by the consumer 20 in the list of purchased items.

When the consumer 20 completes the new product file form (step 122), the consumer 20 submits the form (step 124) to the web server 12. The web server 12 tests the information to make sure the form is complete (step 126). If the form is incomplete, the web server 12 displays an error message (step 128) and then displays the new product file page (step 120) so the consumer 20 can reenter the information. If the form is complete, the web server 12 stores the new product information (step 130) in the database 14. Then, the system 10 displays the updated consumer page (step 86′).

One of the important features of the present invention is the asset transfer feature. When consumers 20 purchase items as gifts or purchase household appliances, consumers 20 often transfer the item to another person, though some time may lapse between purchase and transfer of the item. Furthermore, though warranty registrations are important, the transferee may receive the item with insufficient information about the purchase to complete the registration.

As shown with respect to FIG. 4, the present system automatically completes the warranty registration (step 74). However, when assets are transferred (i.e. given as gifts, sold, transferred as part of the sale of a home, etc.), the warranty information should be transferred as well.

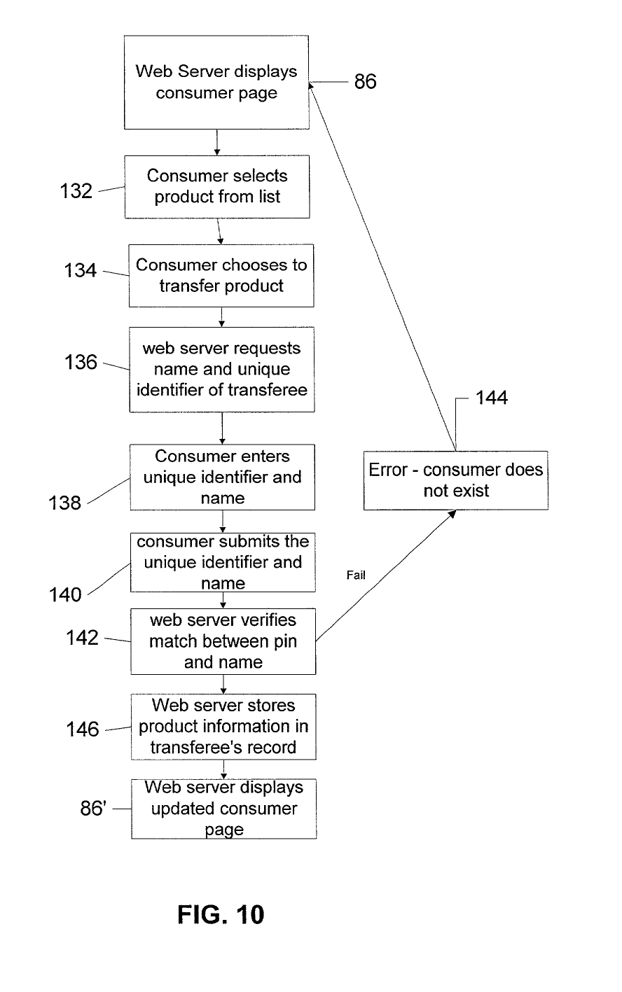

As shown in FIG. 10, consumer 20 can transfer product information from one registered consumer 20 to another. The transferee must register with the system 10. Once the transferee registers, the transferee provides the unique identifier to the consumer 20 and the transfer can be effected.

First the consumer 20 logs on to the system 10 and the web server 12 displays the consumer page (step 86). Then, the consumer 20 selects the item (step 132) and chooses the option to transfer an item to another (step 134). The web server 12 displays a transfer page (step 136), which requests the unique identifier and name ofthe transferee. The consumer 20 enters the unique identifier and name (step 138) and submits the information (step 140) to the web server 12. The web server verifies a match between the unique identifier and name (step 142). If the unique identifier and name combination do not match a registered person on the system 10, the web server 12 displays an error message (step 144) and displays the consumer page (86).

If the unique identifier and name match, the web server 12 transfers the product information to the transferee's datafile (step 146) and displays the updated consumer page (step 86') for the consumer 20.

The system 10 works equally well with services. For instance, if a consumer 20 regularly takes his or her car to a service station for oil changes, the system 10 can capture and store the service transactions. If the consumer 20 later sells the car, the consumer 20 can transfer the service record information to the new owner. Product manuals and other associated information are also made available by the system 10 to the new owner. Thus, transferring an asset to another consumer 20 results in a transfer of the product information, historical information and other relevant information compiled by the system 10.

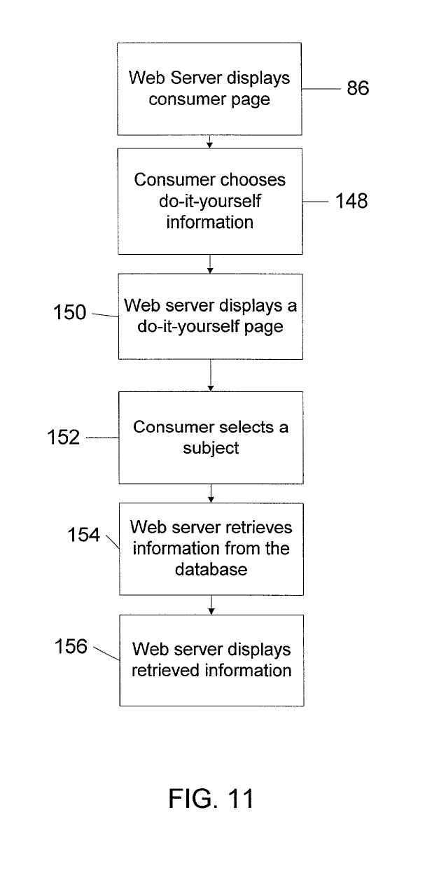

As shown in FIG. 11, the system 10 also provides information for the consumer 20. The consumer 20 can choose to view “do-it-yourself” information, represented on the consumer page by a clickable button. After the web server 12 displays the consumer page (step 86), the consumer 20 chooses to view “DO-IT-YOURSELF” information (step 148) by clicking on a button on the web site. The web server 12 displays a do-it-yourself page (step 150). The consumer 20 selects a subject (step 152), and the web server 12 retrieves do-it-yourself information from the database 14 (step 154). Finally, the web server 12 displays the requested information (step 156).

To further illustrate the do-it-yourself component, the following example is provided. From the consumer page, the consumer 20 chooses to visit the do-it-yourself page. If the consumer 20 clicks on the do-it-yourself link, the web server 12 displays an interactive do-it-yourself interface, which permits the consumer 20 to search, choose a subject, or view objects. The do-it-yourself page automatically displays a subject list or index of do-it-yourself subjects for which it has information. The consumer 20 can choose between the index items which are displayed as hypertext links for easy access. If the consumer 20 chooses one of the subjects, the consumer 20 clicks on the associated link and the web server 12 displays related information. In some instances, the related information will be additional sub-headings of subject matter. For instance, the do-it-yourself page displays subject headings which include electronics, home repair, car repair, etc. The consumer 20 chooses home repair, and the web server 12 displays a list of sub-headings in hypertext format such as electrical, plumbing, carpentry, etc. Again, if the consumer 20 chooses plumbing, an additional sub-heading is displayed such as toilet, shower, sink, etc. Once the consumer 20 clicks on an item which does not lead to another sub-heading, the information is displayed.

In the preferred embodiment, the web server 12 provides a visual interface such that the item is displayed as a visual object to the consumer 20. The consumer 20 can then learn repair information and do-it-yourself information from the site relative to that particular object. The repair information is provided in text and graphical format. Specifically, the object for repair or do-it-yourself is displayed as a three-dimensional object which can be clicked on by the consumer 20. For example, if the consumer 20 clicks on plumbing and choose the sink as the option, the web server 12 will display a three-dimensional picture of a typical sink installed in a counter. The consumer 20 can then click on the faucet of the sink, and the web server 12 will display a close-up view of the faucet together with schematic diagrams of the components of the faucet. Similarly, if the consumer 20 clicks on the drain, the web server 12 will display a close-up view of the drain together with schematics and repair and do-it-yourself information relative to the drain and pipes.

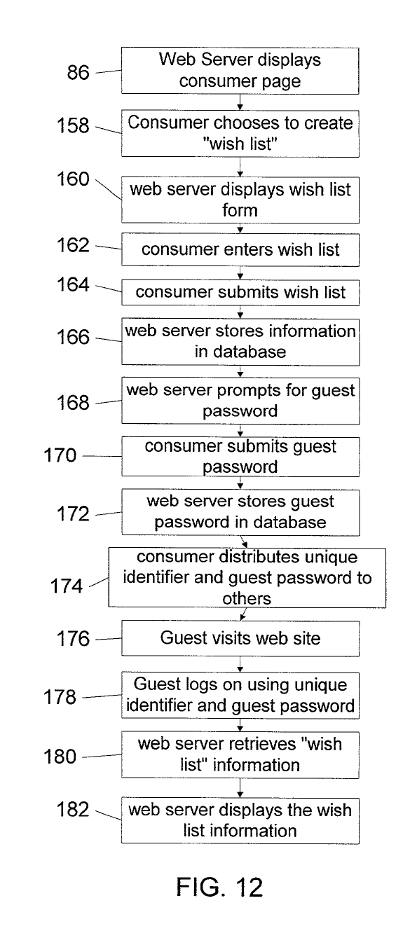

As shown in FIG. 12, the asset management system 10 may also be used as a gift registry or as a gift resource for friends. For families and friends that are separated geographically, a consumer 20 can complete a “gift registry” or “wish list” form that family and friends can access remotely. For the purposes of the following description, “gift registry” and “wish list” can be used interchangeably.

First, the consumer 20 logs in and the web server 12 displays the consumer page (step 86). Then, the consumer 20 chooses to create a wish list (step 158). The web server 12 displays a “wish list” form (step 160). The consumer 20 lists wish list items in the form (step 162). The wish list items are categorized by names, so that a person viewing the wish list will know what types of gifts are wanted by whom. The wish list form provides space for multiple names, for clothing sizes, birth date, etc.

Once the form is complete, the consumer 20 submits the form (step 164). The web server 12 stores the information in the database 14 (step 166). Then, the web server 12 prompts the consumer 20 for a guest password (step 168). The consumer 20 submits a “guest” password (step 170), which the web server 12 stores in the database 14 (step 172). Next, the consumer 20 distributes the web site address, his or her unique identifier and the guest password to others (step 174). When another person visits the web site (step 176) and enters the unique identifier and guest password (step 178), the web server 12 retrieves the wish list information (step 180) from the database 14. The web server 12 displays the wish list information to the guest (step 182). Thus, the system 10 provides a means for the consumer 20 to provide sizing and gift information to others.

In the preferred embodiment, the “wish list” form includes a field for entering multiple e-mail addresses, so that the consumer 20 can enter the e-mail addresses of those to whom he or she wishes to distribute the “wish list”. Once the form is complete, the system 10 generates an e-mail announcement to those people.

Wish lists for kids and/or parents can be added so that friends and family can use the guest unique identifier to view clothing size information and wish list for the purpose of choosing gifts for holidays and/or birthdays. The gift registry is particularly useful for relatives of growing children, whose clothing sizes change rapidly. Families can use the gift registry to keep family members up to date about their children's sizes, so that clothing purchased for various events to be given as gifts will fit.

In an alternative embodiment, the gift registry component of the present invention interacts with gift registry systems of retailers 22, such that items added to the gift registry at the retailer 22 on behalf of the consumer 20 are automatically transmitted and stored in the gift registry of the present invention. Once a consumer 20 has created a gift registry with a retailer and associated the gift registry with the system 10 using the consumer card, the system 10 monitors the retailer's gift registry and updates the gift registry in the database 14 when items are purchased from the retail gift registry. Alternatively, the system 10 can monitor and update gift registries for the retailers as well, monitoring purchases at one gift registry and removing similar or identical products listed in another registry for the same consumer 20, so as to prevent the purchase of identical items.

In an alternative embodiment, the buttons may be named differently and the directories and subdirectories may be named differently than herein described. Furthermore, the buttons may be replaced by hypertext links, Java applets, clickable images or other HTML, XML, DHTML or other web-based object, provided that it permits a consumer to initiate an action.

In the preferred embodiment, the list of subdirectories appears on the left side ofthe computer screen. On the right side, the asset management system 10 displays the product purchase information associated with the current subdirectory. In the event that there are multiple subdirectories, the product purchase information displayed on the right side corresponds with the highlighted subdirectory on the left side. Thus, if the consumer 20 clicks on a sub-folder, all product purchases in that sub-folder are displayed on the right side or display side. The product purchases are displayed as hypertext links, permitting the consumer 20 to click on the purchase to view the purchase specific information, which includes the warranty expiration.

If a consumer 20 moves or if demographic information relative to the consumer 20 changes, the consumer 20 can edit the information on the consumer 20 page. Since this information is used for the purpose of automatically registering warranty information, it is important that this information be kept up to date.

The ability to transfer warranty information to other consumers 22 on the asset management system 10 is advantageous because assets can be transferred and the warranty information can be transferred to the other consumers 22 without paper changing hands. More specifically, washing machines and dryers, refrigerators, dish washers, and large household items which commonly change hands in transfer of a home, may have associated warranties which should be transferred to the new owner at the time of purchase. The transfer also includes access to the related user manuals, product information and historical information (i.e. any service records, upgrades or other modifications). This transfer can be simplified by requiring the purchaser to register with the website and to provide the unique identifier so that the current owner can transfer the assets and associated warranties to the new owners account for easy retrieval.

In the event of a gift purchase, such as a birthday present, a graduation present, etc., the warranty registration information will be automatically entered by the system 10 and the consumer 20 can later transfer the warranty registration to the recipient of the gift once the recipient has registered an account on the system 10.

Associated with the items purchased and recorded in the asset management system 10, the system 10 also provides information resources to consumer 20 on the system 10. Specifically, product user manuals and repair manuals as well as assembly instructions associated with items purchased in the system 10 are available for display. Generally, the vendor 23 or retailer 22 will need to provide the manuals and product information to the system 10, either in paper or electronic form for limited use by registered consumers 20. Thus, necessary instruction information, assembly information, and repair information will always be just be one click away. In addition, the consumer 20 can print the various manuals for later use or for easy highlighting. In the event of an asset transfer (as described in FIG. 10), the product manuals will be available to the transferee, even if they were lost by the previous owner.

The asset management system 10 provides a one-stop resource for consumer 20 to manage their product purchases. The asset management system 10 automatically registers warranties with the manufacturer, adds new purchases when the asset management system 10 card is scanned at the time of purchase, and permits the consumer 20 to transfer and organize assets according to their own organizational system 10.

The asset management system 10 can maintain warranty information, service contracts, repair information, all manuals and repair information, location time and price of all product purchases, the location or position of the product, etc.

The asset management system 10 can also automatically determine the current value of products purchased. Specifically, a computer purchased a year ago will have depreciated in value as updated computers are released by the same manufacturer. The asset management system 10 can monitor the price of existing products and also monitor when products are discontinued to determine the current value of products. The asset management system 10 can keep track of the history of repairs provided that either the asset management card is bar code scanned at the time of repair by the repair facility or that the consumer 20 returns to the asset management system 10 and updates repair information.

Recall and other product update information including product enhancements can be automatically assessed and identified by the asset management system 10. The asset management system 10 will email or contact the consumer 20 according to a preferred contact method when new or enhancement or product recall information is relevant. For example, any recall based on a product number and/or serial number can be automatically identified by the asset management system 10 and purchasers of that particular product can be notified.

All accumulated information is available to the consumer 20 through the Internet 18. With the asset management system 10, there is no longer a need to keep receipts, consumer 20 manuals, warranty or parts manuals. The asset management system 10 eliminates confusion over warranty or extended warranty periods, who is responsible for repairs, and how the warranty people should be contacted.

Essentially, demographic information is appended to the point of sale information. The purchase information is supplemented by warranty registration information and vendor registration requirements such that the complete information is forwarded to the vendor automatically by the asset management system 10. Based on who sponsored the registration of consumer 20, the web server 12 can display sponsor specific home or consumer page information to the consumer 20.

Typically, the vendor or retailer 22 can transmit either electronically or physically vendor manuals associated with purchase items (e.g., consumer 20 manuals, parts manuals, operation manuals, and any warranty information). This is done initially and is updated continuously by the asset management system 10 as new vendors and new products are added to the asset management system's inventory.

The asset management system 10 of the present invention benefits consumers 20, retailers 22 and vendors 23 by automatically registering warranty information at the point of sale providing access to the product manuals, repair manuals, and warranty information for the consumer 20 as well as the retail sales personnel.

Though the asset management system 10 has largely been described with respect to the retail market, the system 10 also has application in the services industry. For example, if a consumer 20 always takes his or her vehicle to the same dealership for repairs and routine maintenance, the dealership has a database record of all of the service performed on the vehicle. However, if a consumer 20 takes his or her vehicle to different shops for repairs and service, the asset management system 10 can consolidate all service records by recording and storing the services performed on the vehicle and the dates of such services. Similarly, ventilation cleaning, chimney cleaning, furnace servicing and other routine (and not so routine) services can be tracked and maintained for the consumer 20.

The asset management system 10 can also be used to automatically generate reminder notices for repairs on automobiles, and/or regularly serviced products. For automobiles for instance, the system 10 can track average mileage for a consumer, by permitting the consumer 20 to record his or her mileage periodically. The system 10 can then monitor service records and remind the consumer 20 that it is time for an oil change based on the average mileage driven by the consumer 20 and the last recorded oil change.

Thus, the asset management system 10 can become an asset management assistant to consumers. The asset management system 10 can generate automatic reminders, monitor product updates/enhancements/recalls, and provide automatic notices to consumer 20 to assist them in their management of their own assets. Finally, the asset management system 10 can generally provide the means for a consumer 20 to track and manage purchase information, service information, warranty information and any other asset information for his or her personal use. Furthermore, the consumer 20 can customize the consumer 20 page to track assets purchased, to provide reminders, to maintain images of assets (for insurance purposes), and even to display the asset's current location or otherwise identify the asset by some key word.

For consumers 20 who use different credit cards for various purchases or who pay cash, the system 10 provides a means for capturing the purchase information and storing the information for later retrieval by the consumer 20. For consumers 20 who purchase items for small businesses, the system 10 provides a means for the consumer 20 to customize the consumer page for readily categorizing such product purchases. The system 10 automates the data entry and allows the consumer 20 to edit and add to the information in the system 10. Finally, the system 10 provides a “one-stop” location for organizing and storing asset information, service records and other valuable information, which can then be retrieved by the consumer 20 over the Internet 18 at the consumer's convenience.

Although the present invention has been described with reference to preferred embodiments, workers skilled in the art will recognize that changes may be made in form and detail without departing from the spirit and scope of the invention.

1. System for managing user information, the system comprising:
a web server providing a web site interface;
a relational database in network communication with the web server, the database being accessible by a plurality of discrete information input sites, the database capable of storing discrete user information and discrete asset information from the plurality of discrete information input sites;
a web portal in communication with an Internet service provider, the web portal providing an Internet connection to the web server; and
Internet access means for allowing a discrete user to interact with the web site interface to access and to manipulate the discrete user information associated with the discrete user.

2. The system according to claim 1, the system further comprising:
input means for electronically retrieving discrete asset information and discrete user identification information and for transmitting the same to the database, wherein the input means retrieves the discrete asset information from a point of sale.

3. The system according to claim 1, the system further comprising:
a web page layout for displaying discrete asset information for a discrete user, the web page layout capable of being modified by the discrete user to create a customized interface specific to the discrete user, the customized interface being stored in the database.

4. The system according to claim 1, the system further comprising:
a software component for completing product registrations on behalf of the discrete user based on the discrete user information in the database and discrete user identification information and discrete asset information retrieved from a point of sale.

5. The system according to claim 1, the system further comprising:
message means for generating a message for the discrete user, the message comprising timely information relating to the discrete asset information.

6. The system according to claim 1, the system further comprising:
a wireless communication interface for permitting the discrete user to interact with the web site interface over a wireless communication device.

7. A method for managing asset information, the method comprising:
capturing asset information related to a discrete user from a plurality of information input sites, the asset information being captured irrespective of method of payment;
storing the asset information in a database, the asset information being associated with the discrete user; and
permitting the discrete user to access the asset information remotely.

8. A method for managing asset information according to claim 7, the method further comprising:
permitting the discrete user to manipulate the asset information remotely.

9. A method for managing asset information, the method comprising:
creating user accounts in a database on a web server, each user account being associated with a discrete user, each user account containing demographic information about the discrete user;
storing asset information for the discrete user in the database, the asset information captured from a plurality of input devices independent of method of payment, the asset information being associated with the user account for the discrete user; and
completing programmatically a product registration for the discrete user, the product registration being associated with the asset information and containing demographic information from the database about the discrete user according to a vendor registration form.
